(19) United States
(12) Patent Application Publication
(10) Pub. No.: US 2006/0078687 A1
(43) Pub. Date: Apr. 13, 2006

(54) Method and apparatus for making a wear resistant plating on a coating blade or the like

(75) Inventor: Kari Korpiola, Helsinki (FI)

Correspondence Address: VOLPE AND KOENIG, P.C., UNITED PLAZA, SUITE 1600, 30 SOUTH 17TH STREET, PHILADELPHIA, PA, 19103, US

(73) Assignee: Pikoblade Oy, Parhalahti (FI)

(21) Appl. No.: 10/532,016

(22) PCT Filed: Oct. 21, 2003
(86) PCT No.: PCT/FI03/00782

§ 371 Date: Apr. 20, 2005

(30) Foreign Application Priority Data
Oct. 22, 2002 (FI) 20021884

(51) Int. Cl. B29D 7/00; B05D 3/00; B05D 3/12; B05D 1/08

(52) U.S. Cl. 427/446; 427/299; 427/177; 427/356; 118/600

(57) ABSTRACT

A method and apparatus for making a wear resistant coating on a treatment blade (4), such as a coating, doctor or creping blade, designed for the treatment of a paper web, in which method the area to be coated is subjected to a preliminary treatment before the coating process to improve the adhesion of the coating material. The adhersion surface (43) of the coating is roughened so that the roughening traces are perpendicular to the longitudinal direction of the coating blade.

The present invention relates to a method for making a wear resistant coating on a treatment blade, such as a coating, doctor or creping blade, designed for the treatment of a paper web. The invention also relates to an apparatus for making a wear resistant coating on such a blade.

In a paper coating process, the paper is generally coated with a paste-like additive containing e.g. a pigment and binding agents. The objective of coating is to improve the properties of the surface of the paper. Coating takes place in the coating unit of a paper machine, where a coating material is spread on the surface of raw paper and smoothed. The coating process may take place e.g. in a blade coater, where the coating material is spread on the surface of the paper and smoothed by means of a coating roller and a coating blade arranged in conjunction with it. The coating blade edge abutting the paper web is beveled. To increase the wear resistance of coating blades, the coating blade edge adjacent to the paper web is coated with a wear resistant material, such as a ceramic material. By using a coated blade, a longer service life, fewer blade changes, less culled paper and more paper of a better quality is produced in the same machine time.

Coating blades can be coated with a wear resistant plating e.g. as disclosed in published patent application FI 71794. In this FI application, ceramic materials, metal oxides or metal carbides are used. The plating is implemented using plasma or flame spraying, by passing a carrier material strip through one or more plating stations, each of which is provided with one or more metal spraying guns adjustable relative to the strip and arranged to deliver a predetermined amount of molten coating material. A wear resistant coating is produced in a stepwise manner by bringing several layers one over the other, which makes it possible to avoid especially the degradation of the properties of the blade, such as its flexibility, during the coating process. Before being coated, the carrier material strip is pretreated e.g. by grinding or brushing it by means of a grinding disc or steel wire brush rotating in its longitudinal direction to a surface roughness below 3 μRa. The strip material can be caused to pass back and forth through the coating station to increase coating material thickness gradually by supplying it from reels placed on either side of the coating station.

Before the coating operation, the area to be coated often has to be pretreated to improve the adhesion of the coating material. Therefore, the blade has to be provided with an expensive adhesion layer coating e.g. by the plasma coating (APS) method, which produces a layer thickness of about 20-30 μm. The adhesion layer coating is made before the actual wear resistant coating. The wear resistant coating can be produced e.g. by the plasma spraying (APS) technique to cause the ceramic coating to melt without applying too much heat to the surface of the blade.

Coating blades can be coated with a wear resistant plating e.g. as disclosed in published patent application FI 71794. In this FI application, ceramic materials, metal oxides or metal carbides are used. The plating is implemented using plasma or flame spraying, by having a carrier material strip run through one or more plating stations, each of which is provided with one or more metal spraying guns adjustable relative to the strip and arranged to deliver a predetermined amount of molten coating material. A wear resistant coating is produced in a stepwise manner by bringing several layers one over the other, which makes it possible to avoid especially the degradation of the properties of the blade, such as its flexibility, during the coating process. Before being coated, the carrier material strip is pretreated e.g. by grinding or brushing it by means of a grinding disc or steel wire brush rotating in its longitudinal direction to a surface roughness below 3 μRa. The strip material can be caused to pass back and forth through the coating station to increase the coating material thickness gradually by supplying it from reels placed on either side of the coating station.

The coating of the blade is typically performed on a straight strip of a length of 3-12 m, and consequently the coating time is long. The coating spray must sweep the area to be coated many times, typically 10-500 times, to obtain a coating of desired thickness (200-350 μm). The adhesion layer coating and the long back-and-forth coating movement lead to a long coating time and an expensive coating.

The problem with the prior-art technique is that the coating will split and crack especially when the blades are being mounted, which involves bending of the blades, and during transportation, the blades being wound as rolls for transportation. Therefore, the rolled-up blades are subjected to a relatively strong force effect caused by the bending, with the result that the coating of the blade is easily detached or damaged.

The object of the present invention is to overcome the drawbacks of prior art and achieve a new type of method and system for making a wear resistant coating at the edge of a coating blade or equivalent. The invention is based on the idea that a preparatory treatment of the adhesion surface for the edge coating is performed by grinding. Adherence of the coating to the smooth steel blade is accomplished by grinding the steel strip to be coated. The roughening is implemented so that the grinding traces are in the direction of motion of the paper web, i.e. perpendicular to longitudinal direction of the coating blade. In addition, the coating operation is performed by the HVOF (High Velocity Oxy Fuel) method, which produces a very durable coating.

The blade to be coated is coarsened to a relatively high degree of roughness, about 3-6 μm Ra, ensuring that the hard metal to be affixed onto the blade will stick fast on the blade surface in all stress conditions. The invention allows the surface roughness required for adherence of the coating to be achieved without deformation of the thin blade.

The grinding can be performed as a reel-to-reel grinding process, wherein the coating operation is accomplished by winding a coating strip around a cylinder in several layers, the blade material being wound on the coating cylinder in an overlapping manner so that the previous layer protects the surface not to be roughened. In this way, the blade can be coated at its edge only while the rest of the blade remains uncoated. After the roughening, the blade preform is wound around a coating drum and is ready to be coated.

The features characteristic of the method and apparatus of the invention are disclosed in the claims below.

The advantages achieved as compared with prior-art blade manufacturing methods: The grinding produces no deformations in the thin blade. By grinding the blade preform, warping of the blade e.g. during grain-blasting is avoided and an expensive thermally sprayed preliminary coating with e.g. nickel chrome plating is unnecessary.

Moreover, the coating blade produced by the method of the invention is very well able to withstand various types of handling, such as e.g. bending occurring during installation and transportation, without the coating being detached or damaged. In addition, the coating arrangement of the invention is simple and economical.

In the following, the invention will be described in detail by means of an example with reference to the attached drawings, wherein

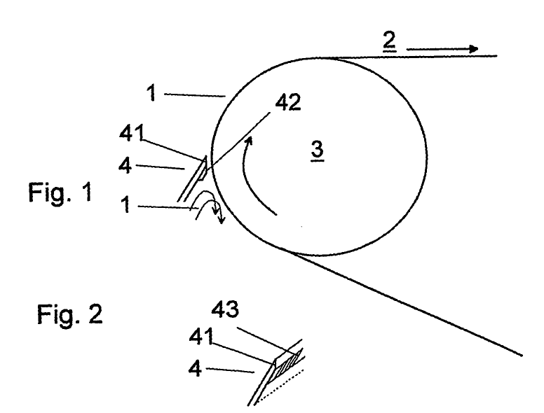

FIG. 1 presents a coating blade produced by an apparatus according to the invention, fitted in conjunction with a coating roller,

FIG. 2 presents a coating blade which has been ground before being coated, and

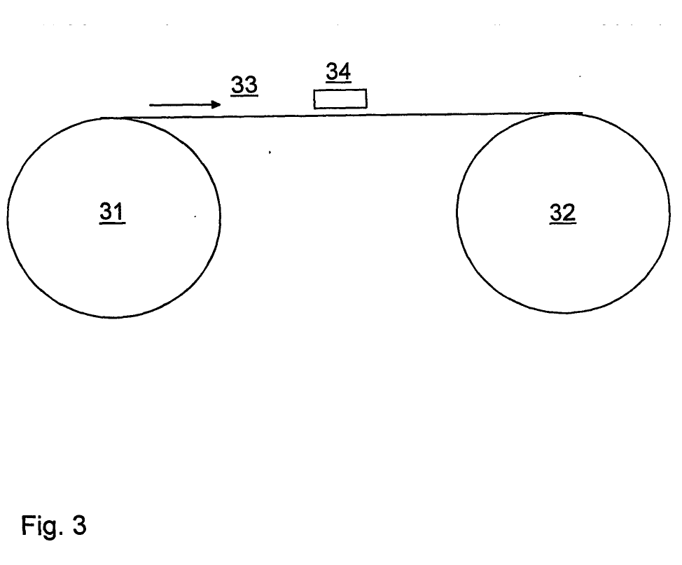

FIG. 3 presents an apparatus according to the invention for making a coating blade.

FIG. 1 presents a blade designed for coating paper in a coater, in which a coating material 1 is applied to the surface of a paper web 2 running between rollers and smoothed by means of a coating roller 3 rotated in the direction indicated by the arrow and a coating blade 4 arranged in conjunction with it. The coating blade edge 41 facing towards the paper web 2 is beveled. To improve the wear resistance of coating blades, the coating blade edge 41 adjacent to the paper web is coated in the direction of web entry with a wear resistant coating 42.

The wear resistant coating 42 may consist of a hard metal, e.g. wolfram carbide, chrome carbide, titan carbide, titan oxide, or aluminum oxide, Al₂O₃ possibly containing additives, such as titan oxide TiO₂.

The roughening of the adhesion surface of the edge coating is implemented by grinding so that the grinding traces 43 are perpendicular to the longitudinal direction of the coating blade. In addition, the blade to be coated is roughened to about 3-6 μm Ra, so the area to be coated will be relatively rough and the coating to be affixed onto the blade will adhere securely to the blade surface in all stress conditions.

According to the invention, the wear resistant coating is produced by a new coating technique according to the invention from a HVOF reel by using an apparatus as illustrated in FIG. 3, through the following steps:

1. Preliminary preparation of the blade, roughening. The surface of the blade 4 to be coated needs to be roughened to about 5-6 μm Ra to ensure that the hard metal 42 to be affixed onto the blade will remain fixed to the blade surface in all stress conditions. Roughening the surface by the traditional grain-blasting method is not applicable because the blade would bend by the modification produced by the grain blasting. By grinding with a rough band or stone 34, it is possible to give the hardened blade preform a surface roughness of about Ra 2-6 μm, which is required for a thermally sprayed coating. The surface roughness required for affixation of the coating is achieved without deformation of the thin blade. The grinding can be performed as a reel-to-reel 31, 32 grinding process, wherein the coating operation is accomplished by winding a coating strip 33 around a cylinder in several layers and the blade material is wound on the coating cylinder in an overlapping manner so that the previous layer protects the surface not to be roughened. After the roughening, the blade preform is wound around a coating drum and is ready to be coated.

2. Coating the blade on a rotating drum: There are several reasons for implementing the coating operation by winding the blade around a rotating drum (d=1 m, I=2 m). A blade strip 33 having a width of 50-100 mm is wound around the rotating drum in a spiral with a pitch of about 5-12 mm. With the strip wound in this way, it is easy to define a blade edge area of 5-12 mm to be coated. The next lap naturally delimits the area to be coated. When the blade is wound in a spiral over the drum, it is possible to produce 50-600 m of finished coated blade in a single operation. The blade is coated by the HVOF method. The coating drum is rotated at a circumferential speed of 1-10 m/s while the surface of the blades on the drum is swept by a coating spray.

This is not possible in traditional technology, by spreading the blades to be coated on a flat surface. Coating the blade on a rotating drum guarantees sufficient cooling of the thin blade, which is easily distorted by heat.

It is obvious to the person skilled in the art that different embodiments of the invention are not limited to the example described above, but that they may be varied within the scope of the claims presented below. In addition to a coating blade, the invention can be applied in the case of other blades for the treatment of a paper web, such as doctor and creping blades.

1. Method for making a wear resistant coating on a treatment blade (4), such as a coating, doctor or creping blade, designed for the treatment of a paper web, in which method the area to be coated is subjected to a preliminary treatment before the coating process to improve the adhesion of the coating material, characterized in that
the adhesion surface (43) of the coating is roughened so that the roughening traces are perpendicular to the longitudinal direction of the coating blade.

2. Method according to claim 1, characterized in that the blade to be coated is roughened to the range of 3-6 μm Ra.

3. Method according to claim 1, characterized in that the coating is performed on a strip-like carrier material in a reel-to-reel coating process, wherein the carrier material is wound in several laps around rollers.

4. Method according to claim 1, characterized in that the coating is produced by the HVOF process.

5. Method according to claim 1, characterized in that a blade strip (33) is wound around a rotating drum in a spiral with a pitch of about 5-12 mm.

6. Apparatus for making a wear resistant coating on a treatment blade (4), such as a coating, doctor or creping blade, designed for the treatment of a paper web, said apparatus comprising a device by means of which the area to be coated is subjected to a preliminary treatment before the coating process to improve the adhesion of the coating material, characterized in that by means of said device, the adhesion surface (43) of the coating is roughened so that the roughening traces are perpendicular to the longitudinal direction of the coating blade.

7. Apparatus according to claim 6, characterized in that the blade to be coated is roughened by means of a grinding device (34) to the range of 3-6 μm Ra.

8. Apparatus according to claim 6, characterized in that the coating is performed on a strip-like carrier material in a reel-to-reel coating process, wherein the carrier material is wound around rollers in a plurality of laps.

9. Apparatus according to claim 6, characterized in that the coating device is a HVOF device.

10. Apparatus according to claim 6, characterized in that a blade strip (33) is wound around a rotating drum in a spiral with a pitch of about 5-12 mm.
